(19) United States
(12) Patent Application Publication
(10) Pub. No.: US 2025/0253566 A1
(43) Pub. Date: Aug. 7, 2025

(54) Terminal, Connector and Connector Assembly

(71) Applicants: Tyco Electronics Technology (SIP) Co., Ltd., Suzhou (CN); Tyco Electronics (Shanghai) Co., Ltd., Shanghai (CN)

(72) Inventors: Weidong Zhang, Shanghai (CN); Wenzheng Ma, Suzhou (CN); Lei Pan, Shanghai (CN); Hongyao (Harvey) Sheng, Suzhou (CN); Liang (Aiden) Chen, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/047,813

(22) Filed: Feb. 7, 2025

(30) Foreign Application Priority Data
Feb. 7, 2024 (CN) 202410175962.4

(51) Int. Cl. H01R 13/02; H01R 13/428; H01R 13/502

(52) U.S. Cl. CPC H01R 13/02; H01R 13/428; H01R 13/502

(57) ABSTRACT

A terminal comprises a single terminal plate, a limit shell, and an elastic contact member. The terminal plate includes top and bottom surfaces opposite each other in a thickness direction and formed with a snap slot. The limit shell is installed on the terminal plate and includes a top plate located above the top surface of the terminal plate, a bottom plate attached to the bottom surface of the terminal plate, and an elastic buckle engaged with the snap slot on the terminal plate to lock the limit shell to the terminal plate. The elastic contact member is installed on the top surface of the terminal plate and faces the top plate of the limit shell. The elastic contact member is adapted for electrical contact with a mating terminal inserted between the elastic contact member and the top plate of the limit shell.

### CROSS-REFERENCE TO RELATED APPLICATION

This application claims the benefit of Chinese Patent Application No. CN202410175962.4 filed on Feb. 7, 2024 in the State Intellectual Property Office of China, the whole disclosure of which is incorporated herein by reference.

### FIELD OF THE DISCLOSURE

The disclosure relates to a terminal, particularly to a terminal for high voltage connectors. In addition, the present invention also relates to a connector comprising the terminal and a connector assembly comprising the connector.

### BACKGROUND OF THE INVENTION

In the prior art, a terminal of a high-voltage connector typically includes a terminal body, a pair of elastic contact members, and a limit shell. The terminal body includes two terminal plates. There is a gap between the two terminal plates that allows for the insertion of a mating terminal. The pair of elastic contact members are set in the gap between two terminal plates and fixed to the inner surfaces of the two terminal plates, respectively. The elastic contact members clamp the mating terminal inserted between them to achieve electrical connection between the terminal and the mating terminal. The limit shell is fitted onto the two terminal plates of the terminal body, used to lock the terminal in the housing of the connector.

As the terminal body includes two terminal plates, the structure of the terminal is complex, the production cost is high, and the manufacturing difficulty is high. In addition, in the prior art, when vibration occurs, the gap between the two terminal plates will change, which can lead to poor electrical contact between the terminal and the mating terminal. Therefore, the terminal of the existing high-voltage connector is not suitable for environments prone to vibration.

### SUMMARY OF THE INVENTION

According to an embodiment of the present disclosure, a terminal comprises a single terminal plate, a limit shell, and an elastic contact member. The terminal plate includes top and bottom surfaces opposite each other in a thickness direction and formed with a snap slot. The limit shell is installed on the terminal plate and includes a top plate located above the top surface of the terminal plate, a bottom plate attached to the bottom surface of the terminal plate, and an elastic buckle engaged with the snap slot on the terminal plate to lock the limit shell to the terminal plate. The elastic contact member is installed on the top surface of the terminal plate and faces the top plate of the limit shell. The elastic contact member is adapted for electrical contact with a mating terminal inserted between the elastic contact member and the top plate of the limit shell.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal according to an exemplary embodiment of the present invention when viewed from the top;

FIG. 2 shows an illustrative perspective view of a terminal according to an exemplary embodiment of the present invention when viewed from the bottom;

FIG. 3 shows an illustrative perspective view of a terminal according to an exemplary embodiment of the present invention when viewed from the rear side;

FIG. 4 shows an illustrative exploded view of a terminal according to an exemplary embodiment of the present invention when viewed from the bottom;

FIG. 5 shows an illustrative exploded view of a terminal according to an exemplary embodiment of the present invention when viewed from the top;

FIG. 6 shows an illustrative perspective view of a terminal according to another exemplary embodiment of the present invention when viewed from the top;

FIG. 7 shows an illustrative perspective view of a terminal according to another exemplary embodiment of the present invention when viewed from the bottom;

FIG. 8 shows an illustrative perspective view of a terminal according to another exemplary embodiment of the present invention when viewed from the rear side;

FIG. 9 shows an illustrative perspective view of a limit shell of a terminal according to another exemplary embodiment of the present invention;

FIG. 10 shows an illustrative exploded view of a terminal according to another exemplary embodiment of the present invention when viewed from the top;

FIG. 11 shows an illustrative perspective view of a terminal according to another exemplary embodiment of the present invention when viewed from the top;

FIG. 12 shows an illustrative exploded view of a terminal according to another exemplary embodiment of the present invention when viewed from one side; and

FIG. 13 shows an illustrative exploded view of a terminal according to another exemplary embodiment of the present invention when viewed from the other side.

### DETAILED DESCRIPTION

Hereinafter, embodiments will be described in detail with reference to the accompanying drawing. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal comprises: a single terminal plate which has top and bottom surfaces opposite each other in its thickness direction and is formed with a snap slot; a limit shell installed on the terminal plate and comprising a top plate located above the top surface of the terminal plate and a bottom plate attached to the bottom surface of the terminal plate; an elastic contact member which is installed on the top surface of the terminal plate and faces the top plate of the limit shell, for electrical contact with a mating terminal inserted between the elastic contact member and the top plate of the limit shell. An elastic buckle is formed on the limit shell, which is engaged with the snap slot on the terminal plate to lock the limit shell to the terminal plate.

According to another embodiment, a connector includes a housing and the above terminal inserted into the housing.

In yet another embodiment, a connector assembly comprises the above connector, and a mating connector which is mated with the connector. The mating connector comprises mating housing used for mating with the housing of the connector, and a mating terminal adapted to be inserted between the elastic contact member of the connector and the top plate of the limit shell to make electrical contact with the elastic contact member of the connector.

### First Embodiment

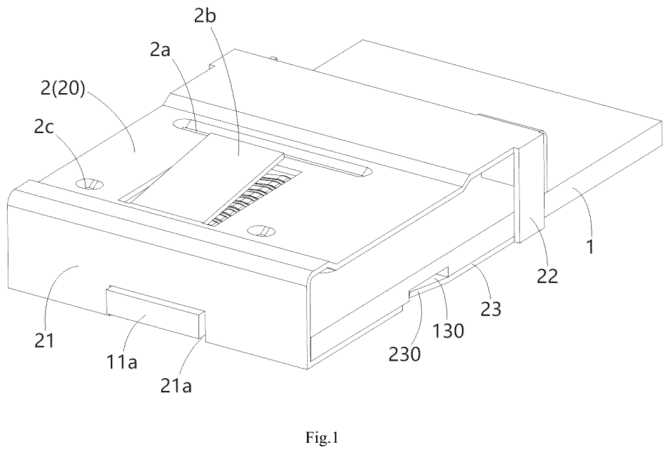

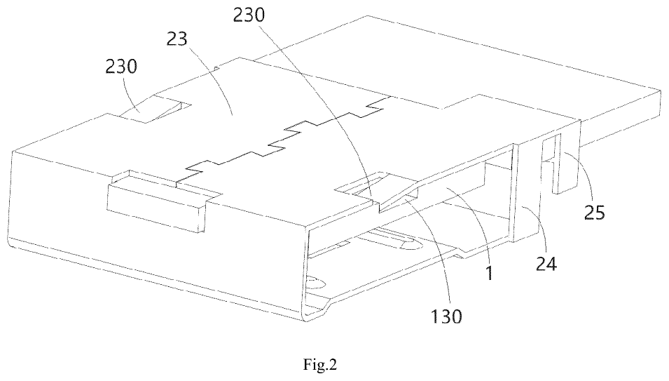

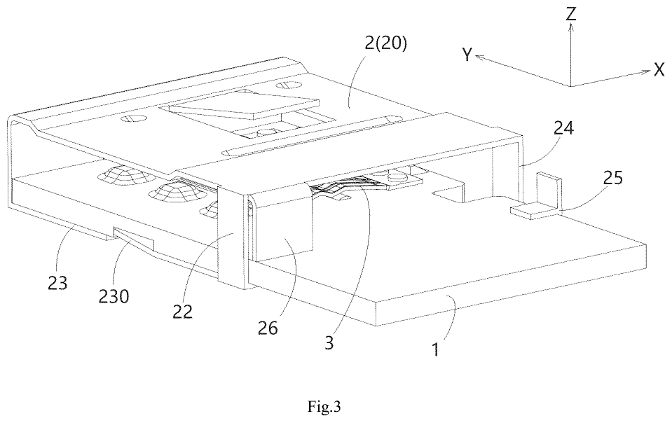

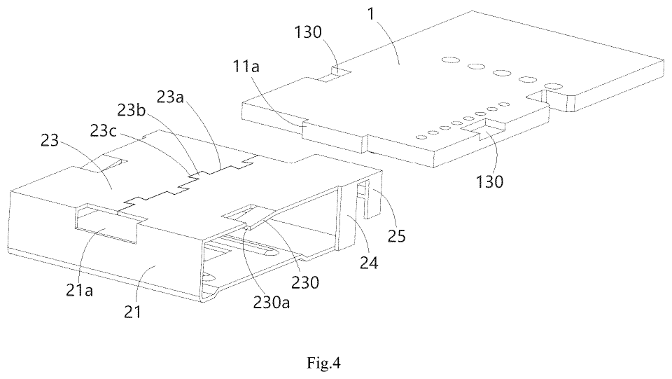

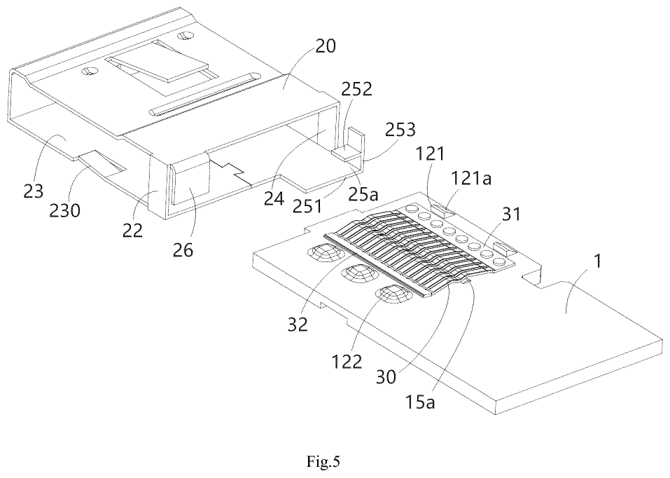

FIGS. 1-5 show the first embodiment according to the present invention. Among them, FIG. 1 shows an illustrative perspective view of a terminal according to an exemplary embodiment of the present invention when viewed from the top. FIG. 2 shows an illustrative perspective view of a terminal according to an exemplary embodiment of the present invention when viewed from the bottom. FIG. 3 shows an illustrative perspective view of a terminal according to an exemplary embodiment of the present invention when viewed from the rear side. FIG. 4 shows an illustrative exploded view of a terminal according to an exemplary embodiment of the present invention when viewed from the bottom. FIG. 5 shows an illustrative exploded view of a terminal according to an exemplary embodiment of the present invention when viewed from the top.

As shown in FIGS. 1-5, in an exemplary embodiment of the present invention, a terminal is disclosed. The terminal includes: a single terminal plate 1, a limit shell 2, and an elastic contact member 3. A single terminal plate 1 has top and bottom surfaces that are opposite in its thickness direction Z, and a snap slot 130 is formed on its bottom surface. The limit shell 2 is installed on the terminal plate 1 and includes a top plate 20 located above the top surface of the terminal plate 1 and a bottom plate 23 attached to the bottom surface of the terminal plate 1. The elastic contact member 3 is installed on the top surface of the terminal plate 1 and faces the top plate 20 of the limit shell 2, for electrical contact with a mating terminal inserted between the elastic contact member 3 and the top plate 20 of the limit shell 2. An elastic buckle 230 is formed on the limit shell 2, which engages with the snap slot 130 on the bottom surface of the terminal plate 1 to lock the limit shell 2 to the terminal plate 1. In the illustrated embodiment, the terminal and the inserted mating terminal are electrically connected to each other via elastic contact member 3.

However, the present invention is not limited to the illustrated embodiments. For example, in one exemplary embodiment of the present invention, the snap slot 130 may be formed on the top surface of the terminal plate 1. The elastic buckle 230 can be engaged with the snap slot 130 formed on the top surface of the terminal plate 1 to lock the limit shell 2 to the terminal plate 1. In another exemplary embodiment of the present invention, snap slots 130 may be formed on both the bottom and top surfaces of the terminal plate 1, and the bottom plate 23 of the limit shell 2 has multiple elastic buckles 230 that are respectively engaged with the snap slots 130 on the bottom and top surfaces of the terminal plate 1.

In the illustrated embodiment, an elastic buckle 230 is formed on the bottom plate 23 of the limit shell 2. The terminal plate 1 has front and rear ends that are opposite in its longitudinal direction Y, and the limit shell 2 is suitable for being fitted onto the front end of terminal plate 1 along the longitudinal direction Y The elastic buckle 230 is in the shape of a spring piece that extends obliquely towards the interior of the limit shell 2, with a rear end connected to the bottom plate 23 and a front end 230a that rests against the inner surface 132 of the snap slot 130.

The limiting shell 2 has two openings opposite each other in the transverse direction X of the terminal plate 1, to allow the mating terminal to be inserted between the elastic contact member 3 and the top plate 20 of the limiting shell 2 along the transverse direction X of the terminal plate 1.

Multiple elastic buckles 230 are formed on the bottom plate 23 of the limit shell 2, and multiple snap slots 130 are formed on the bottom surface of the terminal plate 1. The multiple elastic buckles 230 are respectively engaged with the multiple snap slots 130. Multiple snap slots 130 are symmetrically distributed on two opposite side edges of the bottom surface of the terminal plate 1 in the transverse direction X. Multiple elastic buckles 230 are symmetrically distributed on the two opposite side edges of the bottom plate 23 of the limit shell 2 in the transverse direction X.

The limiting shell 2 further includes a front side plate 21, which is connected between the top plate 20 and the bottom plate 23 of the limiting shell 2 and rests against the front end surface of the terminal plate 1. There is a positioning slot 21a formed in the front side plate 21 of the limit shell 2, and a positioning protrusion 11a formed on the front end surface of the terminal plate 1. The positioning protrusion 11a is fitted in the positioning slot 21a to position the limit shell 2 in the transverse X and thickness direction Z.

The limit shell 2 further comprises a left connection plate 22 and a right connection plate 24. The left connection plate 22 is located on the left side of the rear end of the limit shell 2 and is connected between the left sides of the top plate 20 and the bottom plate 23 of the limit shell 2. The right connection plate 24 is located on the right side of the rear end of the limit shell 2 and is connected between the right sides of the top plate 20 and the bottom plate 23 of the limit shell 2. The left connection plate 22 and the right connection plate 24 are opposite in the transverse direction X and respectively rest on the left and right sides of the terminal plate 1.

The limiting shell 2 further includes a rear limit part 25, which is connected to the rear side of the bottom plate 23 of the limiting shell 2 and formed with a limiting groove 25a. The side of the terminal plate 1 is joined to the limiting groove 25a of the rear limit part 25.

The rear limit part 25 includes a limiting bottom plate 251, a limiting top plate 252, and a limiting side plate 253. The limit bottom plate 251 is connected to the rear side of the bottom plate 23 of the limit shell 2 and rests against the bottom surface of the side edge of the terminal plate 1. The limit top plate 252 is opposite to the limit bottom plate 251 and rests against the top surface of the side edge of the terminal plate 1. The limit side plate 253 is connected between one sides of the limit bottom plate 251 and the limit top plate 252, and is pressed against the side of the terminal plate 1.

The limiting shell 2 further includes a rear limiting plate 26, which is connected to the rear side of the top plate 20 of the limiting shell 2. The lower side of the rear limit plate 26 is pressed against the top surface of the terminal plate 1, and the rear limit plate 26 and the rear limit part 25 are respectively close to the left connection plate 22 and the right connection plate 24.

In the illustrated embodiment, at least one inwardly protruding rib 2a is formed on the top plate 20 of the limit shell 2. The rib 2a extends along the transverse direction X of the terminal plate 1 and is used to apply a predetermined pressure on the inserted mating terminal to ensure reliable electrical contact between the mating terminal and the elastic contact member 3.

An elastic locking piece 2b is formed on the top plate 20 of the limit shell 2, and the elastic locking piece 2b extends obliquely towards the back and outward for engaging with the housing of the connector to lock the terminal in the housing of the connector.

Multiple bulges 2c protruding inward are also formed on the top plate 20 of the limit shell 2. These bulges 2c are used to apply a predetermined pressure on the inserted mating terminal to ensure reliable electrical contact between the mating terminal and the elastic contact member 3.

The elastic contact member 3 includes multiple elastic arms 30 extending along the transverse direction X of the terminal plate 1, and the multiple elastic arms 30 are arranged in a row along the longitudinal direction Y of the terminal plate 1. The multiple elastic arms 30 of the elastic contact member 3 are used to simultaneously make electrical contact with the mating terminal inserted along the transverse direction X of the terminal plate 1.

The elastic contact member 3 further includes a first side edge 31 and a second side edge 32 that are opposite to each other in the transverse direction X of the terminal plate 1, and the first side edge 31 and the second side edge 32 extend along the longitudinal direction Y of the terminal plate 1. Multiple elastic arms 30 are connected between the first side portion 31 and the second side portion 32. One of the first side portion 31 and the second side portion 32 is riveted to the terminal plate 1, while the other is slidably supported on the terminal plate 1.

A first support protrusion 121 and a second support protrusion 122 are formed on the top surface of the terminal plate 1. The first support protrusion 121 is adjacent to the first side edge 31 of the elastic contact member 3, and the second support protrusion 122 is adjacent to the second side edge 32 of the elastic contact member 3. The first support protrusion 121 and the second support protrusion 122 are used to support the inserted mating terminal to prevent the elastic arm 30 of the elastic contact member 3 from being excessively compressed by the mating terminal. A guide inclined surface 121a is formed on the first support protrusion 121 for guiding the mating terminal to be inserted between the elastic contact member 3 and the top plate 20 of the limit shell 2.

A support rib 15a extending along its longitudinal direction Y is also formed on the terminal plate 1. The support rib 15a is located below the elastic arm 30 of the elastic contact member 3 and is used to support the elastic arm 30 of the elastic contact member 3 to prevent excessive deformation of the elastic arm 30 of the elastic contact member 3.

In the illustrated embodiment, the limit shell 2 is a one-piece stamped part, and the bottom plate 23 of the limit shell 2 has a pair of splicing edges 23a, on which slots 23b and protrusions 23c suitable for joint with each other are formed.

In the illustrated embodiment, the slots, and protrusions 23c on the pair of splicing edges 23a are in the shape of a dovetail, T-shaped, or Ω-shaped.

In another exemplary embodiment of the present invention, a connector is also disclosed. The connector includes a housing and a terminal. The terminal is inserted into the housing. In another exemplary embodiment of the present invention, a connector assembly is also disclosed. The connector assembly includes a connector and a mating connector. The mating connector is mated with the connector. The mating connector includes a mating housing and a mating terminal. The mating housing is used to mate with the housing of the connector. The mating terminal is used to be inserted between the elastic contact member 3 of the connector and the top plate 20 of the limit shell 2, in order to make electrical contact with the elastic contact member 3 of the connector.

### Second Embodiment

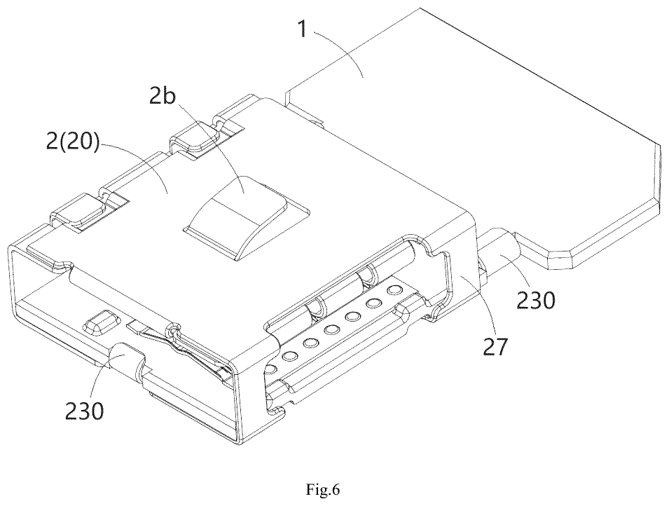

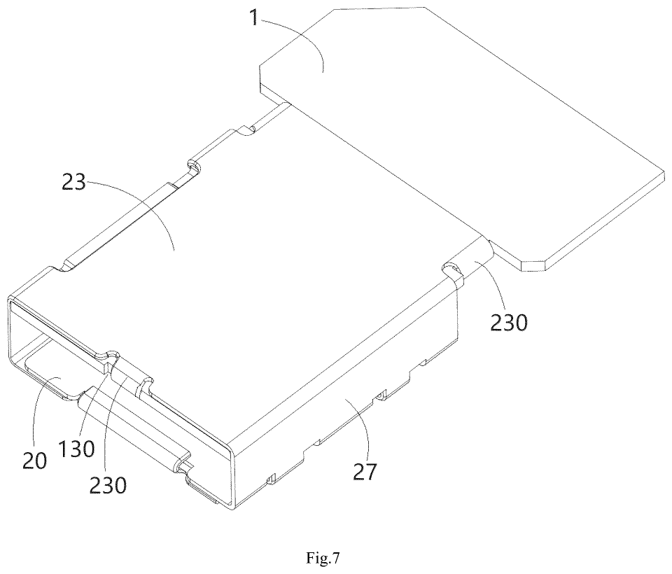

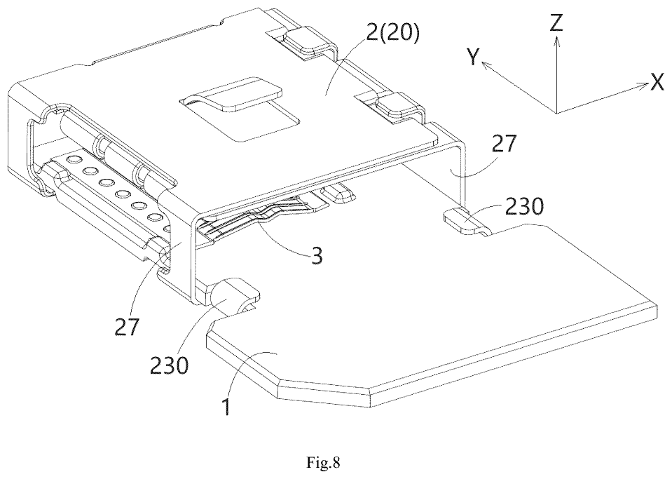

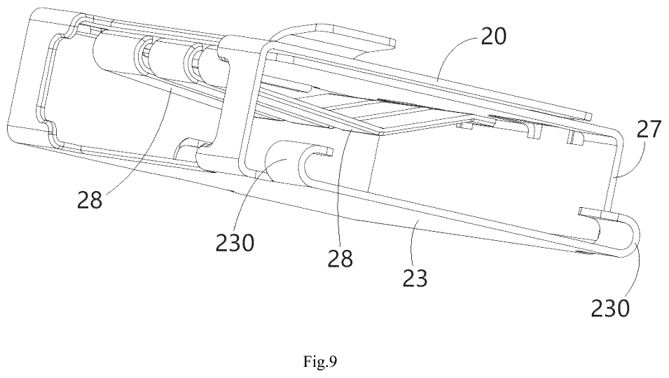

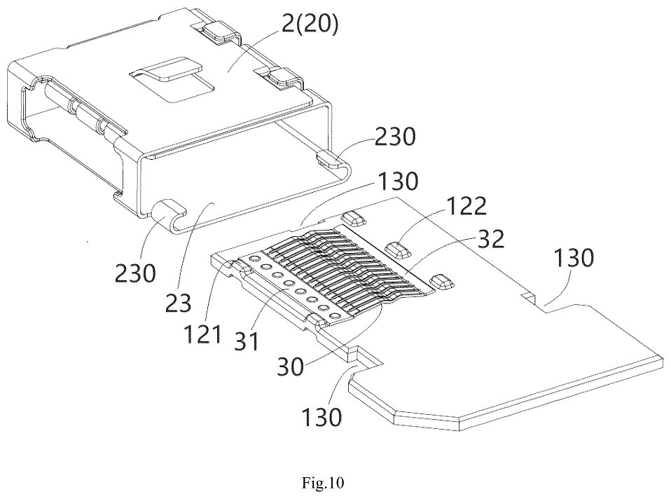

FIGS. 6-10 show a second embodiment according to the present invention. Among them, FIG. 6 shows an illustrative perspective view of a terminal according to another exemplary embodiment of the present invention when viewed from the top. FIG. 7 shows an illustrative perspective view of a terminal according to another exemplary embodiment of the present invention when viewed from the bottom. FIG. 8 shows an illustrative perspective view of a terminal according to another exemplary embodiment of the present invention when viewed from the rear side. FIG. 9 shows an illustrative perspective view of the limit shell 2 of a terminal according to another exemplary embodiment of the present invention. FIG. 10 shows an illustrative exploded view of a terminal according to another exemplary embodiment of the present invention when viewed from the top.

As shown in FIGS. 6-10, in an exemplary embodiment of the present invention, a terminal is disclosed. The terminal includes a single terminal plate 1, a limit shell 2, and an elastic contact member 3. The single terminal plate 1 has top and bottom surfaces opposite each other in its thickness direction Z and is formed with a snap slot 130. The limit shell 2 is installed on the terminal plate 1 and includes a top plate 20 located above the top surface of the terminal plate 1 and a bottom plate 23 attached to the bottom surface of the terminal plate 1. The elastic contact member 3 is installed on the top surface of the terminal plate 1 and faces the top plate 20 of the limit shell 2, for electrical contact with the mating terminal inserted between the elastic contact member 3 and the top plate 20 of the limit shell 2. An elastic buckle 230 is formed on the bottom plate 23 of the limit shell 2, which engages with the snap slot 130 on the terminal plate 1 to lock the limit shell 2 to the terminal plate 1. In the illustrated embodiment, the terminal and the inserted mating terminal are electrically connected to each other via the elastic contact member 3.

In the illustrated embodiment, the terminal plate 1 has front and rear ends that are opposite in its longitudinal direction Y, and the limit shell 2 is adapted to be fitted onto the front end of the terminal plate 1 along the longitudinal direction Y There are snap slots 130 formed on the front, left, and right sides of terminal plate 1, and elastic buckles 230 formed on the front, left, and right sides of the bottom plate 23 of limit shell 2. The elastic buckle 230 is in the shape of a C-shaped elastic clip, which is snapped into the snap slot 130 and clamped onto the side of the terminal plate 1 to lock the limit shell 2 to the terminal plate 1.

The limiting shell 2 has front and rear openings opposite to each other in the longitudinal direction Y of the terminal plate 1, to allow the mating terminal to be inserted between the elastic contact member 3 and the top plate 20 of the limiting shell 2 through the front opening along the longitudinal direction Y of the terminal plate 1. The limit shell 2 also includes a pair of side plates 27 that are opposite in its transverse direction X, and are connected between the top plate 20 and the bottom plate 23. A side opening is formed in one of the pair of side plates 27 of the limit shell 2 to allow the mating terminal to be inserted between the elastic contact member 3 and the top plate 20 of the limit shell 2 through the side opening along the transverse direction X of the terminal plate 1.

The bottom plate 23 has a rear end portion extending backwards beyond the pair of side plates 27 and top plate 20, and elastic buckles 230 on the left and right sides of the bottom plate 23 are located on the left and right sides of the rear end portion of the bottom plate 23, respectively. In this way, the elastic buckles 230 on the left and right sides of the bottom plate 23 will not hinder the mating terminal from being inserted through the side openings between the elastic contact member 3 and the top plate 20 of the limit shell 2.

An elastic locking piece 2b is formed on the top plate 20 of the limit shell 2, and the elastic locking piece 2b extends obliquely backward and outward for engaging with the housing of the connector to lock the terminal in the housing of the connector.

A row of elastic pressing arms 28 is formed on the inner side of the top plate 20 of the limit shell 2. The row of elastic pressing arms 28 is used to apply a predetermined pressure on the inserted mating terminal to ensure reliable electrical contact between the mating terminal and the elastic contact member 3.

The limiting shell 2 is an integral stamped part, the bottom plate 23 of the limiting shell 2 is a single-layer bottom plate, and the top plate 20 of the limiting shell 2 includes a double-layer top plate stacked together, which can be fastened or riveted together.

The elastic contact member 3 includes multiple elastic arms 30 extending along the transverse direction X of the terminal plate 1, and the multiple elastic arms 30 are arranged in a row along the longitudinal direction Y of the terminal plate 1. The multiple elastic arms 30 of the elastic contact member 3 are used to simultaneously make electrical contact with the mating terminal inserted along the transverse direction X of the terminal plate 1.

The elastic contact member 3 further includes a first side edge 31 and a second side edge 32 that are opposite to each other in the transverse direction X of the terminal plate 1, and the first side edge 31 and the second side edge 32 extend along the longitudinal direction Y of the terminal plate 1. Multiple elastic arms 30 are connected between the first side portion 31 and the second side portion 32. One of the first side edge 31 and the second side edge 32 is riveted to the terminal plate 1, while the other is slidably supported on the terminal plate 1.

A first support protrusion 121 and a second support protrusion 122 are formed on the top surface of the terminal plate 1. The first support protrusion 121 is adjacent to the first side edge 31 of the elastic contact member 3, and the second support protrusion 122 is adjacent to the second side edge 32 of the elastic contact member 3. The first support protrusion 121 and the second support protrusion 122 are used to support the inserted mating terminal to prevent the elastic arm 30 of the elastic contact member 3 from being excessively compressed by the mating terminal.

As shown in FIGS. 6 to 10, in another exemplary embodiment of the present invention, a connector is also disclosed. The connector includes a housing and a terminal. The terminal is inserted into the housing. In another exemplary embodiment of the present invention, a connector assembly is also disclosed. The connector assembly includes a connector and a mating connector. The mating connector is mated with the connector. The mating connector includes a mating housing and a mating terminal. The mating housing is used to mate with the housing of the connector. The mating terminal is used to be inserted between the elastic contact member 3 of the connector and the top plate 20 of the limit shell 2, in order to make electrical contact with the elastic contact member 3 of the connector.

### Third Embodiment

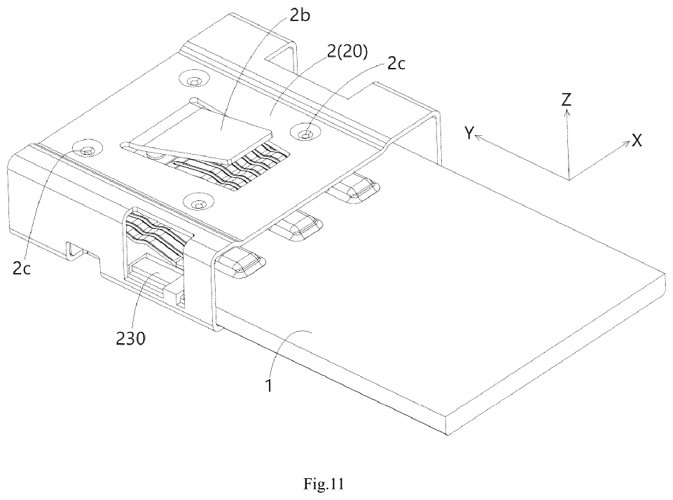

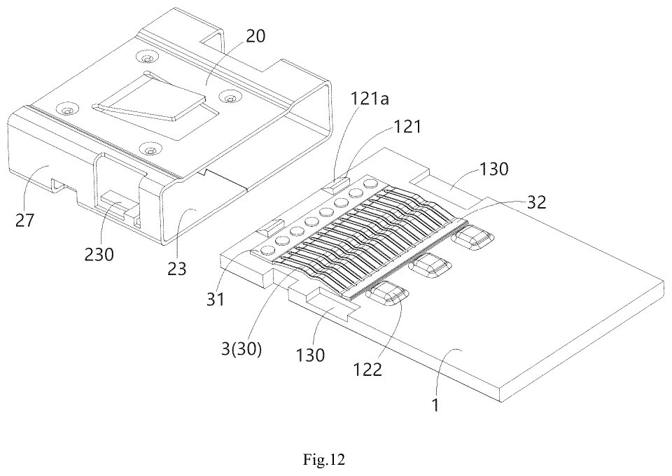

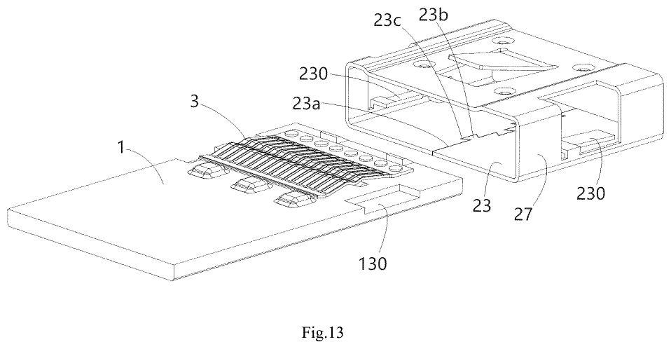

FIGS. 11-13 show a third embodiment according to the present invention. Among them, FIG. 11 shows an illustrative perspective view of a terminal according to another exemplary embodiment of the present invention when viewed from the top. FIG. 12 shows an illustrative exploded view of a terminal according to another exemplary embodiment of the present invention when viewed from one side. FIG. 13 shows an illustrative exploded view of a terminal according to another exemplary embodiment of the present invention when viewed from the other side.

As shown in FIGS. 11-13, in an exemplary embodiment of the present invention, a terminal is disclosed. The terminal includes: a single terminal plate 1, a limit shell 2, and an elastic contact member 3. The single terminal plate 1 has top and bottom surfaces that are opposite in its thickness direction Z, and a snap slot 130 is formed on its top surface. The limit shell 2 is installed on the terminal plate 1 and includes a top plate 20 located above the top surface of the terminal plate 1 and a bottom plate 23 attached to the bottom surface of the terminal plate 1. The elastic contact member 3 is installed on the top surface of the terminal plate 1 and faces the top plate 20 of the limit shell 2, for electrical contact with the mating terminal inserted between the elastic contact member 3 and the top plate 20 of the limit shell 2. An elastic buckle 230 is formed on the limit shell 2, which is connected to its bottom plate 23. The elastic buckle 230 is engaged with the snap slot 130 on the top surface of the terminal plate 1 to lock the limit shell 2 to the terminal plate 1. In the illustrated embodiment, the terminal and the inserted mating terminal are electrically connected to each other via elastic contact member 3.

However, the present invention is not limited to the illustrated embodiments. For example, in one exemplary embodiment of the present invention, the snap slot 130 may also be formed on the bottom surface of the terminal plate 1. The elastic buckle 230 can be engaged with the snap slot 130 formed on the bottom surface of the terminal plate 1 to lock the limit shell 2 to the terminal plate 1. In another exemplary embodiment of the present invention, snap slots 130 may be formed on both the bottom and top surfaces of the terminal plate 1, and the limit shell 2 has multiple elastic buckles 230 that are respectively engaged with the snap slots 130 on the bottom and top surfaces of the terminal plate 1.

In the illustrated embodiment, the terminal plate 1 has front and rear ends that are opposite in its longitudinal direction Y, and the limit shell 2 is adapted to be fitted onto the front end of the terminal plate 1 along the longitudinal direction Y The elastic buckle 230 is in the shape of a spring piece extending obliquely towards the interior of the limit shell 2, with a connecting part connected to the side of the bottom plate 23 and a front end resting on the inner surface 132 of the slot 130.

The limit shell 2 also includes a pair of side plates 27 opposite each other in the transverse direction X of the terminal plate 1. The side plate 27 is connected between the top plate 20 and the bottom plate 23. The limit shell 2 has front and rear openings opposite to each other in the longitudinal direction Y of the terminal plate 1, to allow the mating terminal to be inserted between the elastic contact member 3 and the top plate 20 of the limit shell 2 through the front opening along the longitudinal direction Y of the terminal plate 1.

Multiple elastic buckles 230 are formed on the limit shell 2, and multiple snap slots 130 are formed on the top surface of the terminal plate 1. The multiple elastic buckles 230 are respectively engaged with the multiple snap slots 130. Multiple snap slots 130 are symmetrically distributed on the two opposite side edges of the top surface of terminal plate 1 in the transverse direction X. Multiple elastic buckles 230 are symmetrically distributed on opposite sides of the bottom plate 23 of the limit shell 2 in the transverse direction X.

In the illustrated embodiment, an elastic locking piece 2b is formed on the top plate 20 of the limit shell 2, and the elastic locking piece 2b extends obliquely backward and outward for engaging with the housing of the connector to lock the terminal in the housing of the connector.

Multiple bulges 2c protruding inward are also formed on the top plate 20 of the limit shell 2. These bulges 2c are used to apply a predetermined pressure on the inserted mating terminal to ensure reliable electrical contact between the mating terminal and the elastic contact member 3.

The elastic contact member 3 includes multiple elastic arms 30 extending along the longitudinal direction Y of the terminal plate 1, and the multiple elastic arms 30 are arranged in a row along the transverse direction X of the terminal plate 1. The multiple elastic arms 30 of the elastic contact member 3 are used to simultaneously make electrical contact with the mating terminal inserted along the longitudinal direction Y of the terminal plate 1.

The elastic contact member 3 further includes a first side edge 31 and a second side edge 32 that are opposite to each other in the longitudinal direction Y of the terminal plate 1, and the first side edge 31 and the second side edge 32 extend along the transverse direction X of the terminal plate 1. Multiple elastic arms 30 are connected between the first side edge 31 and the second side edge 32. One of the first side edge 31 and the second side edge 32 is riveted to the terminal plate 1, while the other is slidably supported on the terminal plate 1.

A first support protrusion 121 and a second support protrusion 122 are formed on the top surface of the terminal plate 1. The first support protrusion 121 is adjacent to the first side edge 31 of the elastic contact member 3, and the second support protrusion 122 is adjacent to the second side edge 32 of the elastic contact member 3. The first support protrusion 121 and the second support protrusion 122 are used to support the inserted mating terminal to prevent the elastic arm 30 of the elastic contact member 3 from being excessively compressed by the mating terminal.

A guide inclined surface 121a is formed on the first support protrusion 121 for guiding the mating terminal to be inserted between the elastic contact member 3 and the top plate 20 of the limit shell 2.

The limit shell 2 is a one-piece stamped part, and the bottom plate 23 of the limit shell 2 has a pair of splicing edges 23a, on which slots 23b and protrusions 23c suitable for joint with each other are formed.

In the illustrated embodiment, the slots, and protrusions 23c on the pair of splicing edges 23a are in the shape of a dovetail, T-shaped, or Ω-shaped.

In another exemplary embodiment of the present invention, a connector is also disclosed. The connector includes a housing and a terminal. The terminal is inserted into the housing. In another exemplary embodiment of the present invention, a connector assembly is also disclosed. The connector assembly includes a connector and a mating connector. The mating connector is mated with the connector. The mating connector includes a mating housing and a mating terminal. The mating housing is used to mate with the housing of the connector. The mating terminal is used to be inserted between the elastic contact member 3 of the connector and the top plate 20 of the limit shell 2, in order to make electrical contact with the elastic contact member 3 of the connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a single terminal plate having top and bottom surfaces opposite each other in a thickness direction and formed with a snap slot;
a limit shell installed on the terminal plate and having:
a top plate located above the top surface of the terminal plate;
a bottom plate attached to the bottom surface of the terminal plate; and
an elastic buckle engaged with the snap slot on the terminal plate and adapted to lock the limit shell to the terminal plate; and
an elastic contact member installed on the top surface of the terminal plate and facing the top plate of the limit shell, the elastic contact member adapted for electrical contact with a mating terminal inserted between the elastic contact member and the top plate of the limit shell.

2. The terminal according to claim 1, wherein the snap slot is formed on the bottom or top surface of the terminal plate, and the elastic buckle is engaged with the snap slot on the bottom or top surface of the terminal plate to lock the limit shell to the terminal plate.

3. The terminal according to claim 2, wherein:
the terminal plate has front and rear ends that are opposite in its longitudinal direction, the limit shell is adapted to be fitted onto the front end of the terminal plate along the longitudinal direction from the front end of the terminal plate;
the elastic buckle forms a spring piece extending obliquely towards the interior of the limit shell, with a rear end connected to the bottom plate and a front end resting on the inner side surface of the snap slot.

4. The terminal according to claim 3, wherein the limit shell has two opposite openings opposite to each other in the transverse direction of the terminal plate to allow the mating terminal to be inserted between the elastic contact member and the top plate of the limit shell along the transverse direction of the terminal plate.

5. The terminal according to claim 4, wherein multiple elastic buckles are formed on the bottom plate of the limit shell, and multiple snap slots are formed on the bottom surface of the terminal plate, the multiple elastic buckles are respectively engaged with the multiple snap slots.

6. The terminal according to claim 4, wherein:
the limit shell further includes a front side plate which is connected between the top plate and the bottom plate of the limit shell and rests against the front end surface of the terminal plate; and
a positioning slot is formed in the front side plate of the limit shell, and a positioning protrusion is formed on the front end surface of the terminal plate, the positioning protrusion is fitted in the positioning slot to position the limit shell in the transverse direction and thickness direction.

7. The terminal according to claim 6, wherein the limit shell further includes a rear limit part connected to the rear side of the bottom plate of the limit shell and formed with a limit groove, the side portion of the terminal plate is joined into the limit groove of the rear limit part.

8. The terminal according to claim 4, wherein at least one inwardly protruding rib is formed on the top plate of the limit shell, and the rib extends along the transverse direction of the terminal plate to apply a predetermined pressure on the inserted mating terminal.

9. The terminal according to claim 3, wherein:
the limit shell further includes a pair of side plates opposite to each other in the transverse direction of the terminal plate, wherein the side plates are connected between the top plate and the bottom plate; and
the limit shell has front and rear openings opposite to each other in the longitudinal direction of the terminal plate, allowing the mating terminal to be inserted between the elastic contact member and the top plate of the limit shell through the front opening along the longitudinal direction of the terminal plate.

10. The terminal according to claim 9, wherein multiple elastic buckles are formed on the bottom plate of the limit shell, and multiple snap slots are formed on the top surface of the terminal plate, the multiple elastic buckles are respectively engaged with the multiple snap slots.

11. The terminal according to claim 8, wherein an elastic locking piece is formed on the top plate of the limit shell, and the elastic locking piece extends obliquely towards the back and outward for engaging with a housing of a connector to lock the terminal in the housing of the connector.

12. The terminal according to claim 8, wherein multiple bulges protruding inward are formed on the top plate of the limit shell and are adapted to apply predetermined pressure on the inserted mating terminal to ensure reliable electrical contact between the mating terminal and the elastic contact member.

13. The terminal according to claim 1, wherein:
the terminal plate has front and rear ends that are opposite in its longitudinal direction, and the limit shell is adapted to be fitted onto the front end of the terminal plate along the longitudinal direction from the front end of the terminal plate;
the snap slots are formed on the front, left, and right sides of the terminal plate, and the elastic buckles are formed on the front, left, and right sides of the bottom plate of the limit shell; and
the elastic buckle is in the shape of a C-shaped elastic clip, and is snapped into the snap slot and clamped onto the side of the terminal plate to lock the limit shell to the terminal plate.

14. The terminal according to claim 13, wherein the limit shell has front and rear openings opposite to each other in the longitudinal direction of the terminal plate, allowing the mating terminal to be inserted between the elastic contact member and the top plate of the limit shell through the front opening along the longitudinal direction of the terminal plate.

15. The terminal according to claim 14, wherein:
the limit shell further includes a pair of side plates opposite each other in its transverse direction, the side plates are connected between the top plate and the bottom plate; and
a side opening is formed in one of the pair of side plates of the limit shell to allow the mating terminal to be inserted between the elastic contact member and the top plate of the limit shell through the side opening along the transverse direction of the terminal plate.

16. The terminal according to claim 15, wherein the bottom plate has a rear end extending backwards beyond the pair of side plates and the top plate, and elastic buckles on the left and right sides of the bottom plate are located on the left and right sides of the rear end of the bottom plate, respectively.

17. The terminal according to claim 13, wherein an elastic locking piece is formed on the top plate of the limit shell, and the elastic locking piece extends obliquely towards the back and outward for engaging with a housing of a connector to lock the terminal in the housing of the connector.

18. The terminal according to claim 13, wherein a row of elastic pressing arms is formed on the inner side of the top plate of the limit shell, and is adapted to apply a predetermined pressure on the inserted mating terminal to ensure reliable electrical contact between the mating terminal and the elastic contact member.

19. The terminal according to claim 13, wherein the limit shell is an integral stamped part, the bottom plate of the limit shell is a single-layer bottom plate, and the top plate of the limit shell includes a double-layer top plate stacked together.

20. A connector, comprising:
a housing; and
a terminal inserted into the housing, comprising:
a single terminal plate having top and bottom surfaces opposite each other in a thickness direction and formed with a snap slot;
a limit shell installed on the terminal plate and having:
a top plate located above the top surface of the terminal plate;
a bottom plate attached to the bottom surface of the terminal plate; and
an elastic buckle engaged with the snap slot on the terminal plate to lock the limit shell to the terminal plate; and
an elastic contact member installed on the top surface of the terminal plate and facing the top plate of the limit shell, the elastic contact member adapted for electrical contact with a mating terminal inserted between the elastic contact member and the top plate of the limit shell.
